(19) United States
(12) Patent Application Publication
(10) Pub. No.: US 2008/0173072 A1
(43) Pub. Date: Jul. 24, 2008

(54) Device for detection of residual content and leakage warning for gas canister

(76) Inventor: William Home, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/984,121

(22) Filed: Nov. 14, 2007

(30) Foreign Application Priority Data
Nov. 23, 2006 (TW) 095220630

(51) Int. Cl. G01M 3/04; G01N 37/00

(52) U.S. Cl. 73/40; 73/28.01

(57) ABSTRACT

A device is provided for detecting residual gas content inside a gas canister and issuing a warning of gas leakage. The device includes at least one temperature sensor, one pressure sensor, a calculation/processing circuit, an alarm element, a display device, and a power supply. The temperature sensor is arranged in a gas regulator or periphery of a gas range to detect temperature of surrounding and issue a temperature signal. The pressure sensor is arranged at a high-pressure side of the gas regulator to detect the gas pressure from a gas canister and to issue a pressure signal. The calculation/processing circuit is connected to the temperature sensor and the pressure sensor to receive the temperature signal and pressure signal for calculating the residual gas content in the gas canister and identifying gas leakage occurring in pipe lines and the gas regulator and issuing an alarm signal in response to the identification of gas leakage. The alarm element and the display device are connected to the calculation/processing circuit to issues warning of leakage and display the residual gas content and the warning of leakage. The power supply provides working power to the temperature sensor, the pressure sensor, the calculation/processing circuit, the alarm element, and the display device.

### BACKGROUND OF THE INVENTION

1. Field of the Invention

The present invention relates to a device for detection of residual gas content and leakage warning for a gas canister, and in particular to a device incorporated in connection among a gas range, pipe lines, and a gas canister for detection of the residual gas content and leakage warning for a gas canister.

2. The Related Arts

Gas ranges are a common cooking device, and a complete set of a gas range and a gas canister provides general consumers with a very convenient heating source for cooking foods both indoors and outdoors. However, the residual gas content inside the canister is always a trouble to the users, for there is generally no practical way for the user to determine when the gas will run out. Often, the users determine when the gas will run out based on their past experience. This always results in poor prediction of the time for calling for a new canister of gas, and interrupted replenishment of gas often occurs.

A gas regulator is often connected between a gas canister and a gas range by pipe lines and the connection is susceptible to leakages, which are sometimes not easy identified by the users, leading to risk to the users' lives and property. To avoid such risks, leakage of gas must be identified and fixed as soon as possible.

Related references, such as Taiwan Patent Publication No. 571707, disclose a device for detecting residual gas content in a gas canister. The device is comprised of mechanics and gauges that are disposed inside the gas canister. To install the conventional detection device, the gas canister must be modified. This is in general impractical for existing canisters. The device that is installed in the gas canister also increases the chance of potential gas leakage. In addition, the conventional mechanical device does not provide precise result of detection.

Another reference, Taiwan Patent Publication No. 341347, discloses using a heating element and an associated circuit to detect leakage of gas. Leakage of gas is identified by melting of part, which may cause explosion of the gas contained in the canister. Often malfunctioning occurs due to incorrect melting of the parts. In addition, the conventional device has a slow response.

Therefore, it is desired to have a device for detection of residual gas content and warning of leakage for a gas canister that overcomes the drawbacks of the conventional device discussed above.

### SUMMARY OF THE INVENTION

Thus, an objective of the present invention is to provide a device for detection of residual gas content and leakage warning that carries out precise calculation of the residual gas content inside a gas canister through digital technology.

Another objective of the present invention is to provide a device for detection of residual content and leakage warning for a gas canister, which can be coupled to a gas canister without modification of the gas canister.

A further objective of the present invention is to provide a device to precisely identify and quickly respond to gas leakage occurring in pipe lines or a gas regulator connected to a gas canister.

To realize the objectives, the present invention provides a device for detecting residual gas content inside a gas canister and issuing a warning of gas leakage. The device comprises at least one temperature sensor, one pressure sensor, a calculation/processing circuit, an alarm element, a display device, and a power supply. The temperature sensor is arranged in a gas regulator or periphery of a gas range to detect temperature of surrounding and issue a temperature signal. The pressure sensor is arranged at a high-pressure side of the gas regulator to detect the gas pressure from a gas canister and to issue a pressure signal. The calculation/processing circuit is connected to the temperature sensor and the pressure sensor to receive the temperature signal and pressure signal for calculating the residual gas content in the gas canister and identifying gas leakage occurring in pipe lines and the gas regulator and issuing an alarm signal in response to the identification of gas leakage. The alarm element and the display device are connected to the calculation/processing circuit to issues warning of leakage and display the residual gas content and the warning of leakage. The power supply provides working power to the temperature sensor, the pressure sensor, the calculation/processing circuit, the alarm element, and the display device.

### BRIEF DESCRIPTION OF THE DRAWINGS

The present invention will be apparent to those skilled in the art by reading the following description of preferred embodiments thereof, with reference to the attached drawings, wherein:

FIG. 1 is a block circuit diagram of a device for detection of residual content and leakage warning for a gas canister in accordance with a first embodiment of the present invention;

FIG. 2 is a schematic view of the device of the present invention;

FIG. 3 is a schematic view of a device for detection of residual content and leakage warning for a gas canister in accordance with a second embodiment of the present invention; and

FIG. 4 is a block circuit diagram of a device for detection of residual content and leakage warning for a gas canister in accordance with a third embodiment of the present invention.

### DETAILED DESCRIPTION OF THE PREFERRED EMBODIMENTS

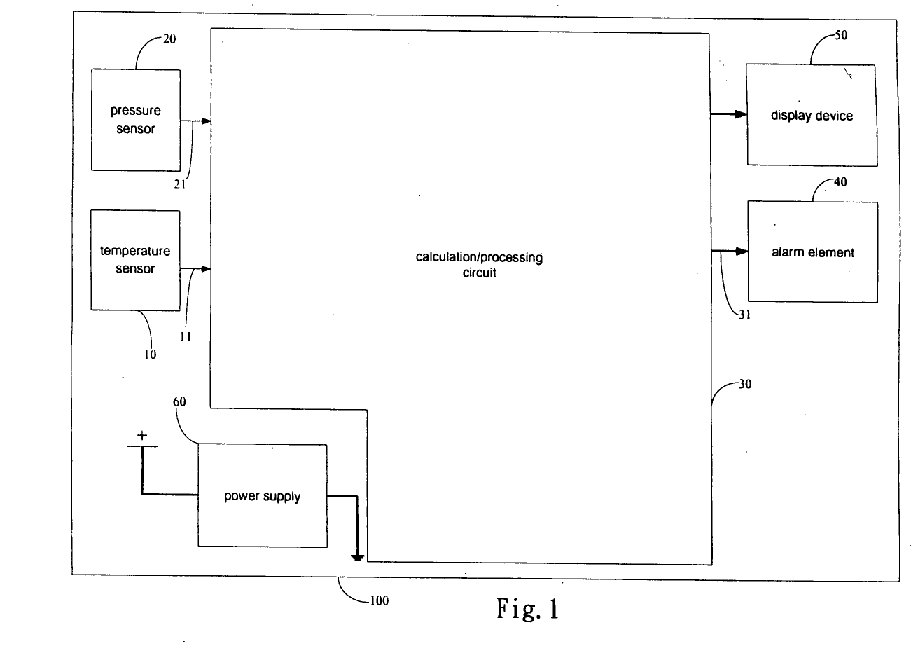

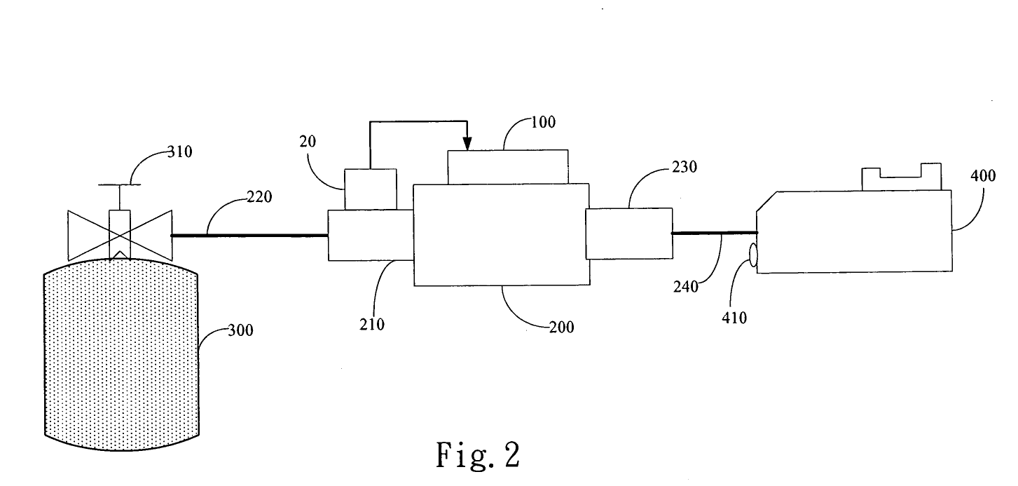

With reference to the drawings and in particular to FIGS. 1 and 2, which show a device constructed in accordance with a first embodiment of the present invention, generally designated with reference numeral 100, the device 100 is arranged between a gas canister 300 and a gas range 400 for detecting the residual content of fuel gas inside the gas canister 300 and also detecting leakage of fuel gas in a gas flow passage from the gas canister 300 to the gas range 400. The device 100 comprises at least one temperature sensor 10, which is arranged in a gas regulator 200 (see FIG. 2) to detect the temperature of the surrounding and to issue a temperature signal 11. The temperature sensor 10 can be of any type and a thermal resistor is taken as an example in the illustrated embodiment.

At least one pressure sensor 20 is arranged at a high-pressure side 210 of the gas regulator 200. The high-pressure side 210 of the gas regulator 200 is connected by a pipe line 220 to the gas canister 300. An opposite low-pressure side 230 of the gas regulator 200 is connected by a pipe line 240 to the gas range 400. The pressure sensor 20 of the gas regulator 200 detects an output pressure of the gas canister 300 and issues a pressure signal 21.

A calculation/processing circuit 30 is connected to the temperature sensor 10 and the pressure sensor 20 to receive and convert the temperature signal 11 and the pressure sensor 21 into corresponding temperature data and pressure data, respectively. Reference temperature, pressure, and volume associated with different types of gas canister 300 are pre-loaded in the calculation/processing circuit 30 whereby the calculation/processing circuit 30 can carry out calculation of a residual content of the gas canister 300 based on the detected temperature data and pressure data of the temperature signal 11 and the pressure signal 21 with reference to the reference temperature, pressure, and volume stored in the circuit 30, which is done with Boyle's Law that, at a given temperature, the volume of a gas is in reversed proportion to the pressure of the gas. The volume of gas inside the gas canister 300 can thus be determined, which volume of gas represents the residual content of gas in the gas canister 300.

Further, the calculation/processing circuit 30 also features determination of gas leakage through calculations with reference to the pressure signal 21. To determine gas leakage, a valve 310 of the gas canister 300 (see FIG. 2) is opened first and a valve 410 of the gas range 400 is also opened. Gas from the gas canister 300 is thus allowed to fill into the pipe line 220, the gas regulator 200, and the pipe line 240. An initial pressure signal 21 is obtained with the pressure sensor 20. The valve 410 of the gas range 400 is then closed, and a second pressure signal 21 of the pressure sensor 20 is sampled after a predetermined period of time, such as five seconds, after the gas range valve 410 is closed. Both pressure signals are supplied to the calculation/processing circuit 30. The difference between pressure data obtained by conversion of the initial pressure signal 21 and that of the second pressure signal 21 is calculated and leakage is identified when the difference exceeds a preset threshold, such as 1 cuft/hour. In addition, leakage can also be identified through detection of zero pressure values of both the initial pressure signal and the second pressure signal. When a leakage is identified, the calculation/processing circuit 30 issues an alarm signal 31.

An alarm element 40 is connected to the calculation/processing circuit 30 to receive the alarm signal 31 and in response thereto, issues warning to a user. The alarm element 40 can be of any know devices, such as a buzzer or a speaker.

A display device 50 is connected to the calculation/processing circuit 30 to show the residual content of gas inside the gas canister 300 and the leakage warning. The display device 50 can be of any known device, such as a liquid crystal display or a light-emitting diode based displaying device.

A power supply 60 supplies a DC working power to the temperature sensor 10, the pressure sensor 20, the calculation/processing circuit 30, the alarm device 40, and the display device 50. The power supply 60 can be of any known device, and a DC battery set is taken as an example in the illustrated embodiment.

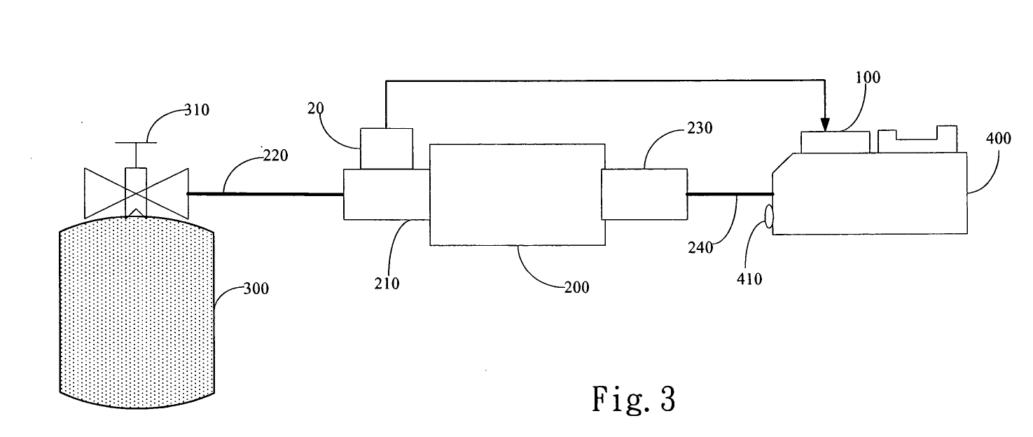

Also referring to FIG. 3, a device for detection of residual gas content and leakage warning in accordance with a second embodiment of the present invention, also designated with reference numeral 100, is shown. In the second embodiment, the device 100 is incorporated in the gas range 400, rather than the gas regulator. The temperature sensor 10 of the device 100 is arranged in a periphery of the gas range 400 and the pressure sensor 20 is arranged at the high-pressure side 210 of the gas regulator 200. The alarm element 40 and the display device 50 are both arranged on the gas range 400. This arrangement allows displaying of the detected gas residual content of the gas canister 300 and issuing of warning to be directly manipulated at the gas range 400.

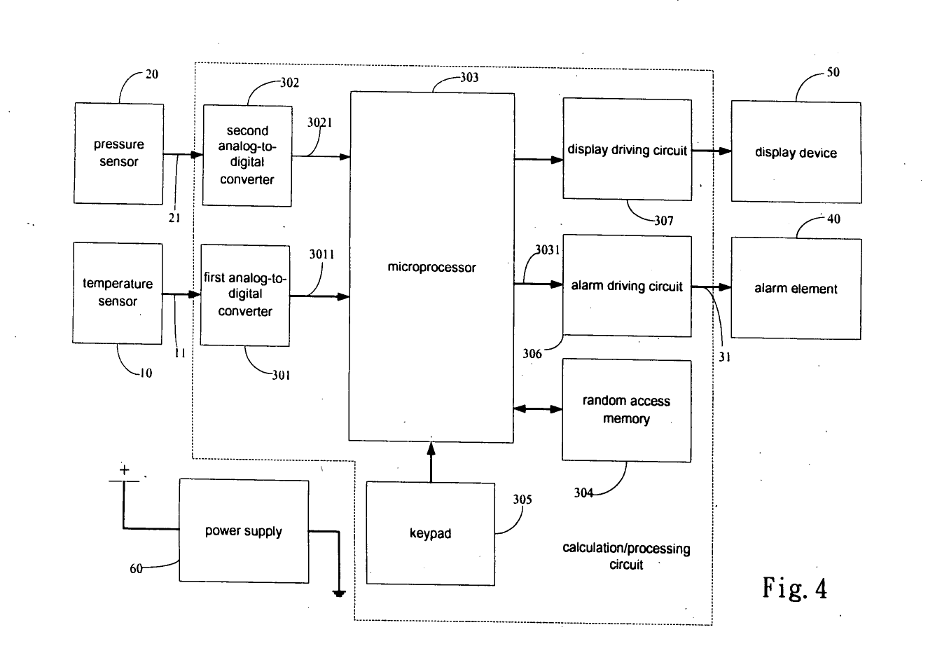

Also referring to FIG. 4, a device for detection of residual gas content and leakage warning in accordance with a third embodiment of the present invention, also designated with reference numeral 100, is shown. In the third embodiment, the calculation/processing circuit 30 comprises a first analog-to-digital converter 301, a second analog-to-digital converter 302, a microprocessor 303, a random access memory (RAM) 304, a keypad 205 comprising a plurality of pushbuttons, an alarm driving circuit 306, and a display driving circuit 307. The first analog-to-digital converter 301 is connected to the temperature sensor 10 to receive and convert the temperature signal 11 from the temperature sensor 10 into a temperature data 3011, which is then applied to the microprocessor 303.

The second analog-to-digital converter 302 is connected to the pressure sensor 20 to receive and convert the pressure signal 21 into a pressure data 3021, which is then applied to the microprocessor 303.

The microprocessor 303 is connected to both the first and second analog-to-digital converters 301, 302 to receive the temperature data 3011 and the pressure data 3021 respectively, whereby the microprocessor 303 carries out calculation of the residual content of gas inside the gas canister 300 in accordance with the relationship among temperature, pressure, and volume indicated by Boyle's Law. Also, an initial pressure data 3021 and a second pressure data 3021 obtained from initial and second pressures signals 21 that are taken at different time points by the pressure sensor 20, as discussed above, are processed to determine gas leakage along the gas flow path consisting the pipe lines 220, 240 and the gas regulator 200 and to issue an alarm activation signal 3031 in response to the identification of a gas leakage.

The random access memory 304 is connected to the microprocessor 303 and is loaded with reference data for temperature, pressure, gas residual content for different types of gas canister 300. The data are accessible by the microprocessor 303 for calculation of actual residual content of gas inside the gas canister 300. The random access memory 304 also provides storage for the initial pressure data and second pressure data 3021 discussed above for the microprocessor 303 to determine if there is a gas leakage.

The keypad 305 is connected to the microprocessor 303 for entering instructions regarding booting, shut-down, calculation of residual gas content, inspection of gas leakage, resetting of alarm, switching of displayed data to the microprocessor 303 to initiate the microprocessor 303 to carry out corresponding operation and processing. The keypad 305 may comprise a keyboard.

The alarm driving circuit 306 is connected between the microprocessor 303 and the alarm element 40 to receive the alarm activation signal 3031 from the microprocessor 303 and, in response thereto, supply an alarm signal 31 to the alarm element 40 for issuing of a warning.

The display driving circuit 307 is connected between the microprocessor 303 and the display device 50 for displaying the residual gas content, the status of operation, and status of waning through the display device 50.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A device for detection of residual gas content in a gas canister and issuing a warning of gas leakage, comprising:
at least a temperature sensor adapted to detecting a temperature of surrounding and issue a temperature signal;
at least a pressure sensor arranged at a high-pressure side of a gas regulator, the high-pressure side being connected to the canister to detect an output pressure of the gas canister and to issue a pressure signal;
a calculation/processing circuit connected to the temperature sensor and the pressure sensor to receive and convert the temperature signal and the pressure signal into corresponding data of temperature and pressure, the calculation/processing circuit being pre-loaded with reference data of temperature, pressure, and volume for calculation of residual gas content inside the gas canister, the calculation/processing circuit also receiving an initial pressure signal and a second pressure signal from the pressure sensor to identify a gas leakage and issue an alarm signal;
an alarm element connected to the calculation/processing circuit to receive the alarm signal and issues the warning of gas leakage;
a display device connected to the calculation/processing circuit to display the residual gas content and status of warning; and
a power supply that supplies DC working power to the temperature sensor, the pressure sensor, the calculation/processing circuit, the alarm element, and the display device.

2. The device as claimed in claim 1, wherein the temperature sensor comprises a thermal resistor.

3. The device as claimed in claim 1, wherein the temperature sensor is arranged in a gas regulator.

4. The device as claimed in claim 1, wherein the temperature sensor is arranged at periphery of a gas range.

5. The device as claimed in claim 1, wherein the calculation/processing circuit comprises
a first analog-to-digital converter connected to the temperature sensor to receive and convert the temperature signal from the temperature sensor into the temperature data;
a second analog-to-digital converter connected to the pressure sensor to receive and convert the pressure signal from the pressure sensor into the pressure data;
a microprocessor connected the first and second analog-to-digital converters to receive the temperature data and the pressure data respectively and to calculate the residual gas content inside the gas canister according to a relationship among temperature, pressure, and gas volume, the microprocessor also operable to identify the gas leakage based on the pressure data associated with the initial pressure signal and the second pressure signal from the pressure sensors and issuing an alarm activation signal;
a random access memory connected to the microprocessor and loaded with reference data for temperature, pressure, and residual gas content for different types of the gas canister, which reference data are supplied to the microprocessor for calculation of the residual gas content, the random access memory also serving as storage for the pressure data of the initial and second pressure signals for identification of gas leakage by the microprocessor;
a keypad connected to the microprocessor for entering instructions regarding booting, shut-down, calculation of residual gas content, inspection of gas leakage, resetting of alarm, switching of displayed data to the microprocessor to initiate the microprocessor to carry out corresponding operation and processing;
an alarm driving circuit connected between the microprocessor and the alarm element to receive the alarm activation signal from the microprocessor and, in response thereto, supply the alarm signal to the alarm element for issuing of the warning of gas leakage; and
a display driving circuit connected between the microprocessor and the display device for displaying the residual gas content, status of operation, and the status of waning through the display device.

6. The device as claimed in claim 1, wherein the microprocessor is connected to a keyboard.

7. The device as claimed in claim 1, wherein the alarm element comprises a buzzer.

8. The device as claimed in claim 1, wherein the alarm element comprises a speaker.

9. The device as claimed in claim 1, wherein the display device comprises a liquid crystal display.

10. The device as claimed in claim 1, wherein the display device comprises a light-emitting diode based displaying device.

11. The device as claimed in claim 1, wherein the power supply comprises a DC battery set.
